(19) United States
(12) Patent Application Publication
(10) Pub. No.: US 2007/0085321 A1
(43) Pub. Date: Apr. 19, 2007

(54) INTERIOR PAGE STRUCTURE OF A BOOK

(76) Inventor: Yu-Sheng Huang, Bangiao City (TW)

Correspondence Address: MARC E. HANKIN, ESQ., 11414 THURSTON CIRCLE, LOS ANGELES, CA, 90049, US

(21) Appl. No.: 11/470,196

(22) Filed: Sep. 5, 2006

(30) Foreign Application Priority Data
Sep. 5, 2005 (TW) 0094215248

(51) Int. Cl. B42D 1/00

(52) U.S. Cl. 281/3.1

(57) ABSTRACT

An interior page structure of a book is secured between the cover sheets of a book to allow for opening the book flat for reading or writing, comprising at least one interior page unit which is made by folding over a sheet of paper and then cutting it into a plurality of pages having a spine thereon; with a plurality of discontinuous incisions provided on the spine; the interior page unit is coated on the spine with a layer of adhesive that may be introduced into the incisions of the spine after the task of gathering leaves has been done, thus each page of the interior page unit is permitted to be bound together with a desirable effect, and each sheet can be opened and laid flat as the adhesive involved has a high degree of elasticity, even when dried.

### RELATED APPLICATIONS

This application claims the benefit of priority of Taiwan Patent Application No. 0094215248, filed on Sep. 5, 2005.

### FIELD OF INVENTION

This invention relates, generally, to an interior page structure of a book that is suitable, for example, for use as a notepad or a printing pad, or for a book for reading, more particularly to an interior page structure that is capable of being opened and laid flat when displaying the inner pages opened up for reading or writing.

### BACKGROUND

There are several well-known methods of binding pages into a book. Many of these methods, such as the so-called “perfect binding” systems are mainly suitable for high volume binding, while other methods, such as “comb binding” and “spiral wire” binding are applicable to the short-run market. Some of these methods are not desirable for cosmetic and practical reasons.

There are a variety of books or notebooks (these terms are used interchangeably herein) now available in the world-wide market that, more or less, exhibit the circumstance that the interior pages are curved during reading, resulting in the transfiguration of the text, images, and characters, as well as the inconvenience during writing, more particularly, as such a circumstance will be more serious, especially when coming near the edge of the page that is adjacent to the spine.

One type of print-on-demand binding method is known as the “tape binding” method. A well-designed tape binder produces a cosmetically handsome book with durable, strongly bound pages. Typically, tape binders utilize a pre-coated adhesive strip that is wider than the thickness of the book to attach the spine of a group of documents. The strip is then formed up for a short distance along the front and the back cover sheets and the adhesive, thus adjacent to the front and rear sheets, secures the tape to the two covers. Usually the adhesive employed is a hot melt product, although pressure sensitive glues have been used alone or in combination with hot melts. One such invention is disclosed in a patent application entitled: “Document tape binding system with automatic tape feed, tape indicia sensing, spine printing method and post-bind automation mechanisms” to Bilbrey, published as No. 2004/0028505.

There exist other on-demand printing and binding patents, including U.S. Pat. No. 7,014,182 to Marsh, for example, which teaches an apparatus and a method for binding a perfect bound book that may be printed on-demand. Marsh discusses the prior art, such as a soft cover perfect bound book with a spine that is imbedded in the adhesive which, upon curing, securely adheres the pages of the book to one another and to the center portion of the cover, permitting the book to be opened to any page without any pages coming loose.

Marsh also discusses the prior art in which a hot melt adhesive is applied to the spine of the book, and is clamped in place during assembly, to ensure that the adhesive sticks to the pages of the book and the spine simultaneously.

U.S. Pat. No. 5,601,389 to Minami discloses an automatic book binding machine for cut-sheets, in which a nozzle applies a linear band of glue along one edge of the cut sheets, and a pressing plate aligns the sides of each cut-sheet, pressing the glue-applied areas of the cut-sheets together. Minami also discusses the prior art perfect binding method, and the drawbacks of the conventional method, many of which are also overcome by the present invention.

U.S. Pat. No. 6,685,415 to Rush, et al., discloses a bookbinding structure and method to bind a stack of sheets into a book using a heat activated adhesive matrix and a layer of pressure activated adhesive along the spine edge of the stack of sheets.

U.S. Pat. No. 6,726,423 to Hocking discloses a method for binding together into a book a plurality of paper sheets coated on one side with hot-melt adhesive, and on the other surface a resistive strip.

None of the foregoing inventions allow the book to lay flat, across the inner aspect of the spine, when the book (notebook) is being read or written upon. There are spiral binding methods, such as those owned by the GBC company, known as “Cerloc”, that use spiral wires, plastic combs, plastic spiral wires, or the like, but those methods are both expensive and bulky. Furthermore, to create such bindings, the paper must be pre-punched with a specific pattern into which the combs or wires must be inserted. There are drawbacks to such methods, such as creating paper dust, hole fragments, and noise during the punching process.

In book binding, a leaf (leaves) refers to the smallest, standard physical unit of paper in a printed piece; in the case of books and pamphlets, a leaf usually has a printed page on each side of a leaf. In book binding, a gathering refers to the group of leaves formed after the printed sheet has been folded to the size of the book but before it is combined in proper sequence with its fellows, prior to binding.

U.S. Pat. No. 6,955,493 to Acquaviva, et al., discloses a method for binding together stapled signatures; a signature being a group or gathering of leaves printed together on a sheet of paper which is folded, bound with other signatures and trimmed to form a book or pamphlet; i.e., a section or grouping of pages in a book resulting from printing and binding methodology. The Acquaviva invention discloses flexible binding material that can be used to bind together pre-punched pages of a book, such that the signatures may be laid flat when the book is opened. Nevertheless, that invention does not permit the individual pages, or leaves, to be opened flat.

Concerning the above mentioned drawbacks that exist in the existing books, a method for solving said technical problems has been disclosed in TW Patent No. 533141, (referred to as Patent No. 141 below). This patent is directed to a method for manufacturing a notebook (book) with the key point residing in the course of manufacturing the notebook (book); an adhesive to be used on the spine of the notebook (book) possesses the nature of softness, as well as a material to be adhered to the same is also made of softened material; as such, after the notebook (book) has been manufactured, the pages will not exhibit a curved surface near the spine of the notebook (book) and the notebook (book) is capable of laying flat on the table when opened for reading or writing thereon.

The whole manufacturing procedures disclosed in the Patent No. 141 successively comprises printing on the paper, folding over the paper, gathering leaves, threading and compressing, coating on the spine with adhesive, adhering a softened material to the spine, cutting into volumes, making cover sheet and applying a protective layer thereto.

As can be seen from the above description, in order to prevent the pages of the notebook (book) from being curved when being turned and opened, even though the method disclosed in Patent No. 141 adopts a method of applying softened adhesive to bind the spine together and adhering a softened material to the spine, because the interior pages are stitched together by the way of threading in the process of gathering leaves, the pages bound by the way of threading are more or less drawn along by the thread and thus the condition of a curved page surface still occurs when the pages are opened.

Thus it can be seen, the above noted prior art does not disclose a technique capable of completely solving the problem that the interior pages of the notebook will be curved while turning and trying to lay flat for reading and/or writing. Therefore, there is still a need to find a new technique that will resolve this problem better.

There remains, therefore, a long felt need in the art for a book that may be opened flat without the pages curving up, and without bulky and expensive wires or combs, to make it easier for reading and/or writing.

### SUMMARY OF THE INVENTION

The present invention is directed towards overcoming the above shortcomings by disclosing an interior page structure of a book that completely solves the problem that the interior pages of the book will be curved when they are turned and opened.

The interior page structure of the present invention is designed as follows: the interior page structure includes at least one interior page unit having a plurality of sheets of paper, and a plurality of discontinuous incisions are provided on the spine of the unit, the interior page unit was coated on the spine with an adhesive that is still elastic even after it has dried, which allows the adhesive to permeate into the incisions.

The interior page structure disclosed by the present invention is desirable with respect to the perfect binding effect, and the interior pages also possess a desirable characteristic of laying open flat because of the expandable and elastic features of the adhesive used.

### BRIEF DESCRIPTION OF THE DRAWINGS

FIG. 1 is a perspective view of the interior page structure integrated in a cover sheet disclosed in present invention, which is in an open configuration.

FIG. 2 is a schematic view of the interior page structure of the present invention, showing that the paper has a surface area that can be folded over and cut into eight sheets with equal area, each separate sheet can be printed with lines, text, images, or the like.

FIG. 3 is a schematic view of the interior page structure of the present invention, wherein the paper of FIG. 2 has been counter-folded to a sheet with half the area of the full sheet in FIG. 2 and showing that a discontinuous cutting line is formed by a sawtooth cutter.

FIG. 4 is a partially enlarged schematic view of the discontinuous cutting line formed by the sawtooth cutter in FIG. 3, showing the broken line-like incisions on the paper.

FIG. 5 is a schematic view of the interior page structure of the present invention, showing that the paper has a surface area that can be folded over into quarter sheets with equal area, with each separate sheet having printing with lines, text, images, or the like.

FIG. 6 is a schematic view of the quarter area sheet of FIG. 5 showing that a discontinuous cutting line may be formed by a sawtooth cutter in the center line of the pages, thus forming pages with one-eighth the area of the original page.

FIG. 7 is a schematic view of the pages with one-eighth the area of the original page of FIG. 6 that has been counter-folded along the discontinuous cutting line.

FIG. 8 is a perspective view of the action of gathering leaves of individual interior page units to form a stack of leaves for the interior page structure of the present invention.

FIG. 9 is a schematic side view showing that the pages, having been processed by the procedure of gathering leaves, are coated with an adhesive on the binding edge of the interior page structure and that some of the adhesive can be introduced into the discontinuous cutting line incisions of the present invention.

FIG. 10 is a schematic side view of the interior page structure of the present invention after having been coated with the adhesive, and after a sheet of outer material has been adhered to the spine thereof.

FIG. 11 is a schematic side view of part of the interior page structure of the present invention showing the bound book, with the stacks of leaves in an open and laying flat orientation.

### DESCRIPTION OF REFERENCE NUMBERS FOR THE MAIN ELEMENTS

10 . . . Interior page structure

100 . . . Page(s)

12 . . . Interior page unit(s)

120 . . . Paper

122 . . . Lines

124 . . . Discontinuous cutting line

126 . . . Incision(s)

14 . . . Adhesive

16 . . . A sheet of material

18 . . . Cover sheet

20 . . . Sawtooth cutter

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention shall not be interpreted to limit the scope the invention.

In the following description, certain terminology is used to describe certain features of one or more embodiments of the invention. For instance,

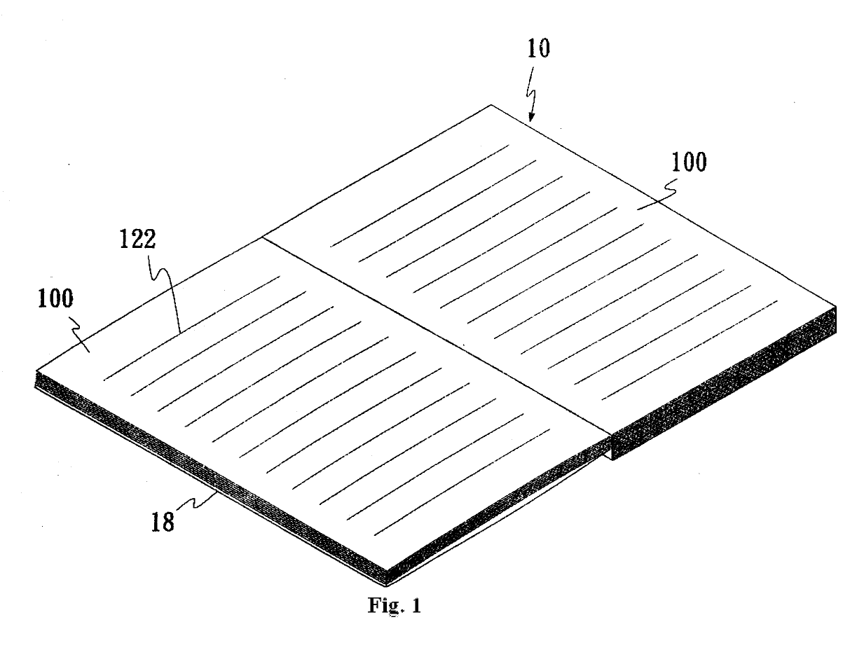

FIG. 1 is a schematic view of the interior pages structure of present invention being inserted into the cover sheet of a book, and said pages are in a opened up and lay flat condition; it can be seen from this figure, said interior page structure 10 is made by a plurality of interior page units 12 being bound together to form a volume, and the pages 100 will never be shown as curved surface when they are opened up.

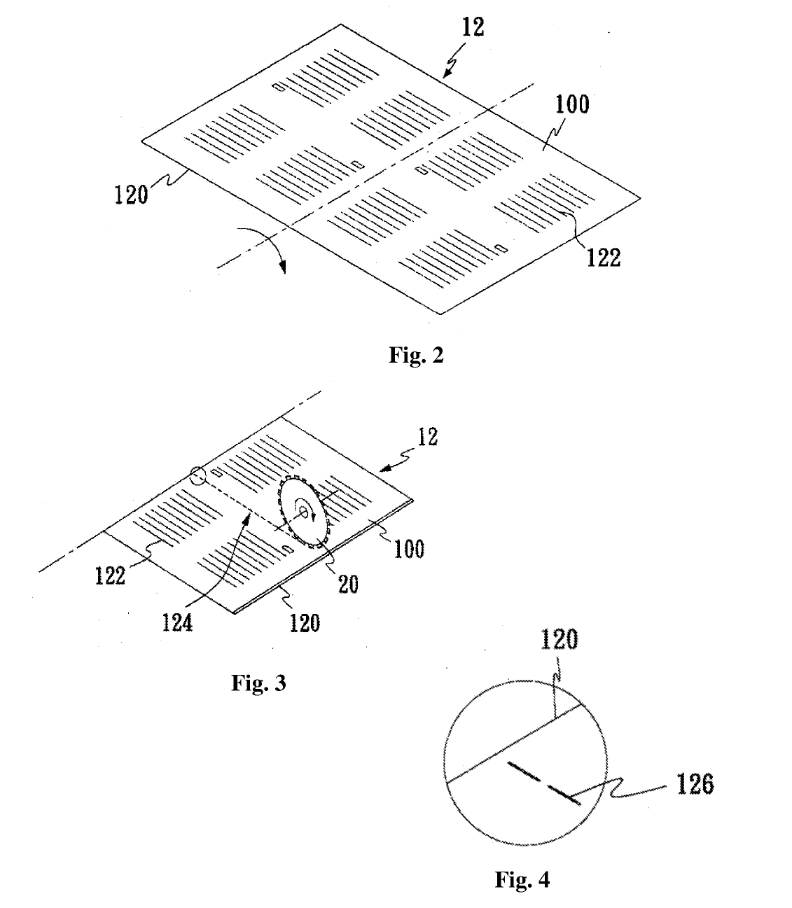

The further description will be made below with regard to the interior page unit 12. Referring to FIGS. 2-7, the page interior structure 12 is formed by folding over a sheet of paper 120 one or more times, supposing that the paper has a surface area that can be folded over and cut into eight sheets with equal area, as illustrated in FIG. 2, and the pages are printed with various lines 122 necessary, text and image beforehand.

After the printing procedure has been carried out, firstly, the paper 120 could be counter-folded to sheets with half area, and then, as illustrated in FIG. 3, a discontinuous cutting line 124 is formed by engaging a sawtooth cutter 20 with wheel type or otherwise cutter tools along the central line on the paper which has been folded over previously, and thus broken line-like incisions 126 formed on the paper 120, as shown in FIG. 3.

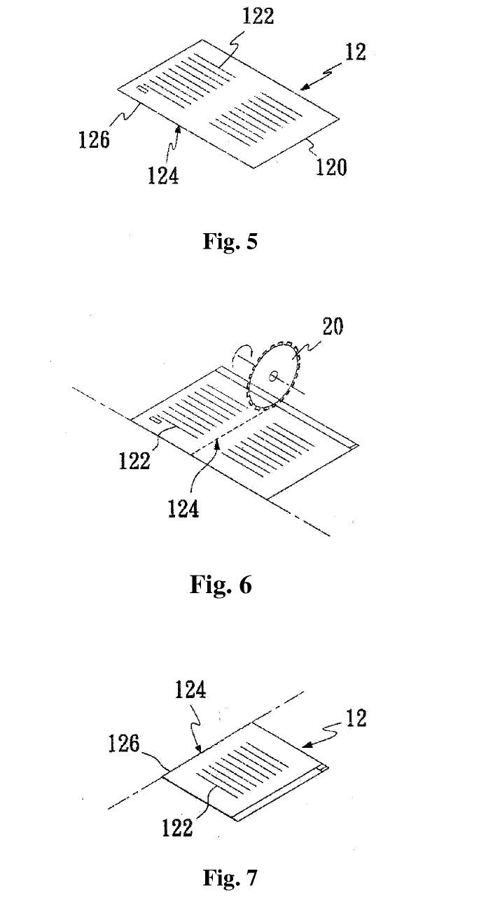

Following that, the paper 120 may be further folded over to be pages having surface areas corresponding to a quarter of the originals as shown in FIG. 5 by using the discontinuous cutting line 124 as the fold line for counter-folding.

A discontinuous cutting line 124 also can be designated in the central line of said pages with a quarter of original areas by the same way, and then, as illustrated in FIG. 6, said sheets with a quarter of areas are folded over once more to form the pages having the surface areas corresponding to only eighth of the originals by taking the discontinuous cutting line 124 as the fold line for counter-folding, as described in FIG. 7.

After foregoing procedures of cutting and folding over being completed, a volume of interior page unit 12 with eight pages is available via cutting off excess materials on edges.

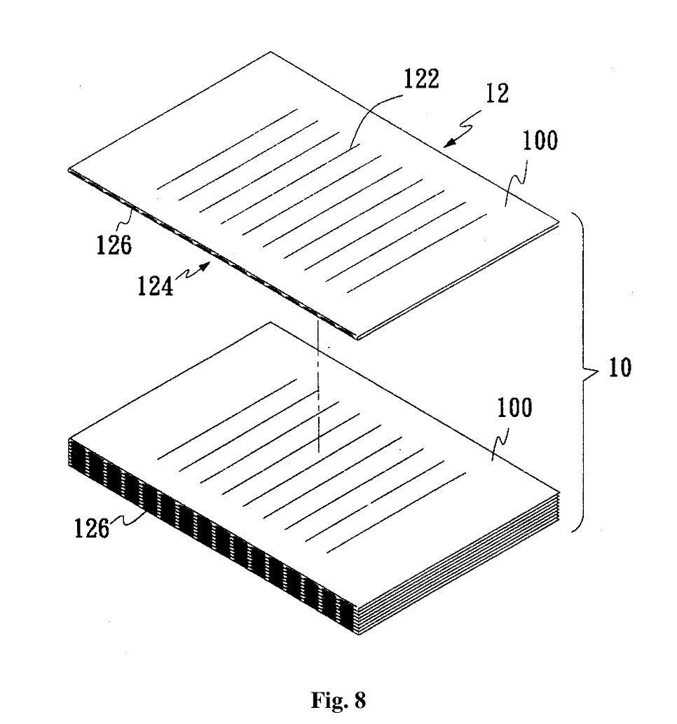

Referring to FIG. 8, after sheets of paper 120 are all transformed into a plurality of interior page units 12 in the form of volume via above-mentioned procedures, all of the interior page units 12 will proceed with the task of gathering leaves, that is, stacking the interior page units 12 on the top of each other in turn to form a volume.

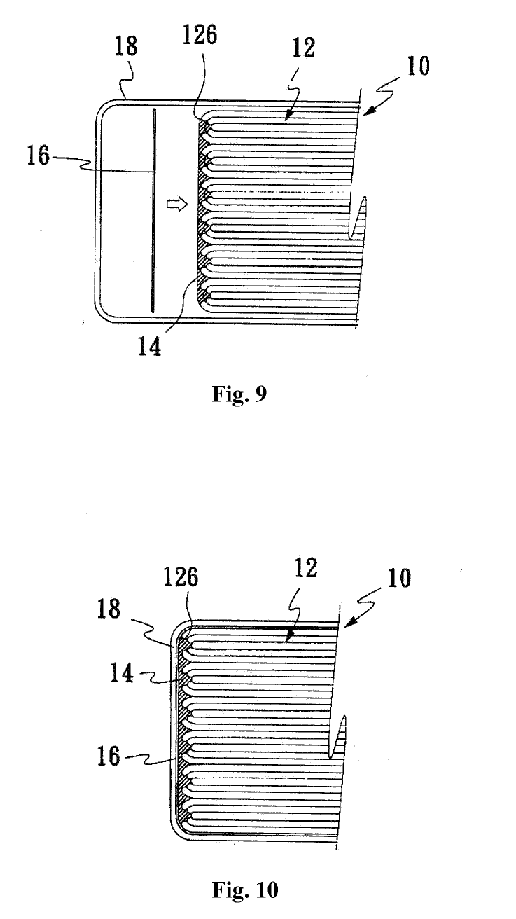

After the task of gathering leaves has been done, the interior page units 12 can be coated on the exterior of the spine with an adhesive 14, so that all the interior page units 12 overlapping on each other could be bound together in this manner, as illustrated in FIG. 9. Furthermore, a plurality of incisions 126 positioning in the spine can be formed by the discontinuous cutting lines 124 when the pages are in the state of folding over, because the spine of interior page units 12 have the discontinuous cutting lines 124 formed by the manner of cutting. Then, it is a naturally matter that some of the adhesive 14 can be introduced into the incisions 126, all the pages 100 of interior page units 12 are allowed to be bound together with a desirable effect. It should be particularly noted that the adhesive 14 is made of the materials with great elasticity even being dried up.

Moreover, a sheet of material 16 can be adhered to the spine of interior page units 12 whose task of gathering leaves has been done after said interior page units are coated on the spines with the adhesive 14, as described in FIG. 10. That enables all the interior page units to be bound together more compactly, and compresses the adhesive 14 to be introduced into the incisions 126 more deeply, thereby imparting a more desirable binding among the pages 100.

Finally, after the adhesive being dried up, the final task of cutting and forming a volume can be carried out, that is, to form an interior page structure 10 by combining a plurality of interior page units 12 in the form of a volume. Further, the first page after the process of cutting and forming a volume can be put on the cover sheet 18 and thus a volume of book can be finished according to above; wherein the cover sheet 18 could be made of a material of thick paperboard, or others materials either with better intensity on texture or with a function of water-proof.

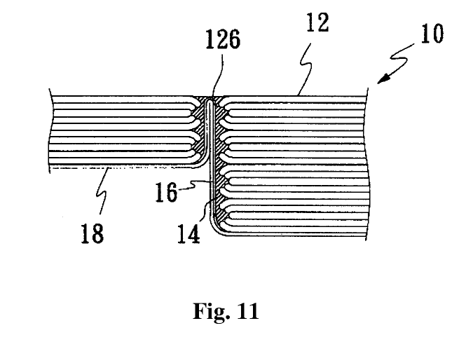

As stated above, the interior page structure of the book disclosed in present invention achieves the most desirable binding effect only by using an adhesive comparing to the prior art. Moreover, as described in FIG. 11, since present invention does not adopt the way of stitching the pages together by threads, when the pages of a book are opened up for reading, it is capable of displaying the condition of lay-flat completely and will never occur the problem of curved surface of interior pages.

What described above are the preferred embodiments of the invention, it is not intended to be limitations to the scope of the invention. The ordinary skilled person in the art should understand that the scheme of the present invention can be modified or substituted, without departing from the spirit and scope of the technical scheme of the present invention.

What is claimed is:

1. An interior page structure of a book, comprising:
at least one interior page unit, having a plurality of sheets of pages and a spine being designated at said unit, and a plurality of discontinuous incisions being provided on the spine; and
a layer of elastic adhesive coated on the spine of the interior page unit, so as to be introduced into said discontinuous incisions.

2. The interior page structure of a book of claim 1, wherein said interior page unit is formed by folding over a sheet of paper and further cutting it apart.

3. The interior page structure of a book of claim 1, wherein the surface of said interior pages has printed on it images.

4. The interior page structure of a book of claim 1, wherein the spine of the interior page unit is coated with the adhesive, after that a sheet of material is adhered thereto.
